(19) United States
(12) Patent Application Publication
(10) Pub. No.: US 2016/0060848 A1
(43) Pub. Date: Mar. 3, 2016

(54) CIRCULATING WATER PROVIDING SYSTEM AND CIRCULATING WATER PROVIDING METHOD

(71) Applicant: KABUSHIKI KAISHA TOSHIBA, Tokyo (JP)

(72) Inventor: TAKASHI YOSHIZU, Yokkaichi (JP)

(21) Appl. No.: 14/656,916

(22) Filed: Mar. 13, 2015

(30) Foreign Application Priority Data
Sep. 2, 2014 (JP) 2014-178126

(51) Int. Cl. E03B 7/07; F24F 5/00; F25D 17/02; G05D 16/20

(52) U.S. Cl. CPC E03B 7/075; G05D 16/2013; F24F 5/0003; F25D 17/02

(57) ABSTRACT

In one embodiment, a circulating water providing system includes a tank configured to store water, and a first pipe configured to feed the water to flow in a direction from the tank to one or more manufacturing apparatuses. The system further includes a second pipe configured to feed the water to flow in a direction from the one or more manufacturing apparatuses to the tank, and a third pipe configured to return the water from the second pipe to the tank. The system further includes a detector configured to detect a pressure of a gas in the second pipe, a valve disposed on the third pipe, and a controller configured to control an opening degree of the valve, based on the pressure of the gas detected by the detector.

### CROSS REFERENCE TO RELATED APPLICATION

This application is based upon and claims the benefit of priority from the prior Japanese Patent Application No. 2014-178126, filed on Sep. 2, 2014, the entire contents of which are incorporated herein by reference.

### FIELD

Embodiments described herein relate to a circulating water providing system and a circulating water providing method.

### BACKGROUND

In general, a semiconductor manufacturing clean room includes a circulating water providing system to cool devices in a plurality of semiconductor manufacturing apparatuses with circulating water. The circulating water providing system includes a feed main pipe for feeding the circulating water to these manufacturing apparatuses, and a return main pipe for returning the circulating water from these manufacturing apparatuses.

In a normal state, the return main pipe in the circulating water providing system is filled with the circulating water. However, when the load of the system decreases due to the decrease in the number of the manufacturing apparatuses or the like, the controller in the system tries to maintain the feed pressure of the circulating water at a certain level, so that the amount of the circulating water in the system decreases and the return main pipe is no longer filled with the circulating water. As a result, a space containing a gas is generated in the return main pipe. In this case, when the pressure of the gas in the return main pipe becomes a negative pressure, a return sub-pipe connecting each manufacturing apparatus and the return main pipe is pressed by the atmospheric pressure, and a malfunction occurs to deform the return sub-pipe. This is because the return sub-pipe is generally made of a softer material than the return main pipe. As a result, the amount of the circulating water in the system does not attain a rated amount. In this case, a circulating water pump in the system tries to compensate the lack of the amount of the circulating water by increasing the amount of the circulating water, and therefore the circulating water pump consumes too much electric power.

### BRIEF DESCRIPTION OF THE DRAWINGS

FIG. 1 is a schematic diagram illustrating a configuration of a circulating water providing system of a first embodiment;

FIG. 2 is a cross sectional view illustrating a connection portion of a return sub-pipe of the first embodiment;

FIG. 3 is a cross sectional view illustrating a connection portion of a return sub-pipe of a comparative example of the first embodiment;

FIG. 4 is a cross sectional view for explaining a problem associated with the connection portion of the comparative example of the first embodiment;

FIG. 5 is a cross sectional view for explaining an advantage associated with the connection portion of the first embodiment; and

FIG. 6 is a cross sectional view illustrating the connection portion of the return sub-pipe of a modification of the first embodiment.

### DETAILED DESCRIPTION

Embodiments will now be explained with reference to the accompanying drawings.

In one embodiment, a circulating water providing system includes a tank configured to store water, and a first pipe configured to feed the water to flow in a direction from the tank to one or more manufacturing apparatuses. The system further includes a second pipe configured to feed the water to flow in a direction from the one or more manufacturing apparatuses to the tank, and a third pipe configured to return the water from the second pipe to the tank. The system further includes a detector configured to detect a pressure of a gas in the second pipe, a valve disposed on the third pipe, and a controller configured to control an opening degree of the valve, based on the pressure of the gas detected by the detector.

### First Embodiment

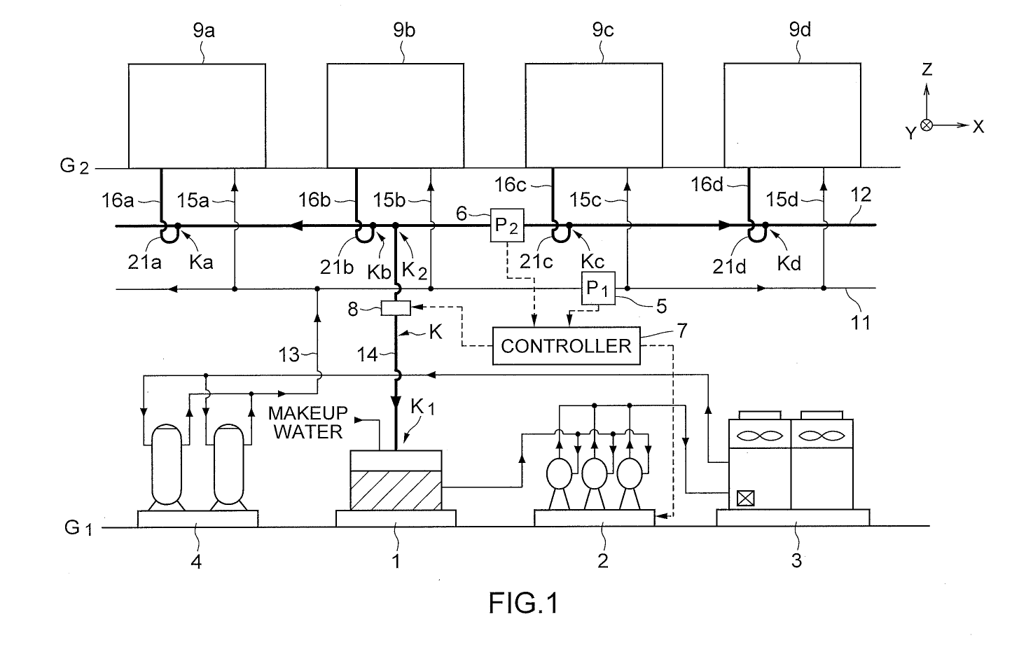

FIG. 1 is a schematic diagram illustrating a configuration of a circulating water providing system of a first embodiment.

The circulating water providing system of FIG. 1 includes a circulating water tank 1 as an example of a tank, a circulating water pump 2, a circulating water cooling tower 3, a circulating water filter 4, a first pressure detector 5, a second pressure detector 6 as an example of a detector, a controller 7, and a control valve 8 as an example of a valve. The circulating water tank 1, the circulating water pump 2, the circulating water cooling tower 3 and the circulating water filter 4 of the present embodiment are placed on a floor surface G₁.

The circulating water providing system of FIG. 1 cools devices in plural (four in this case) semiconductor manufacturing apparatuses 9a to 9d with circulating water. The number of the semiconductor manufacturing apparatuses 9a to 9d to which the circulating water is provided may be other than four. These semiconductor manufacturing apparatuses 9a to 9d is an example of one or more manufacturing apparatuses. The semiconductor manufacturing apparatuses 9a to 9d of the present embodiment are installed on a floor surface G₂ which is higher than the floor surface G₁.

The circulating water providing system of FIG. 1 further includes a feed main pipe 11 as an example of a first pipe, a return main pipe 12 as an example of a second pipe, a pipe 13, a pipe 14 as an example of a third pipe, feed sub-pipes 15a to 15d, and return sub-pipes 16a to 16d as examples of a connection pipe.

FIG. 1 shows an X direction and a Y direction which are parallel to the floor surfaces G₁ and G₂ and are perpendicular to each other, and a Z direction which is perpendicular to the floor surfaces G₁ and G₂. In this specification, +Z direction is treated as an upper direction, and −Z direction is treated as a lower direction. For example, a positional relationship between the circulating water tank 1 and the semiconductor manufacturing apparatuses 9a to 9d is expressed such that the circulating water tank 1 is located below the semiconductor manufacturing apparatuses 9a to 9d. In the present embodiment, −Z direction may match the gravity direction, or may not match the gravity direction.

The circulating water tank 1 stores the circulating water. The circulating water in the circulating water tank 1 is fed by the circulating water pump 2 to the semiconductor manufacturing apparatuses 9a to 9d via the circulating water cooling tower 3 and the circulating water filter 4. The circulating water cooling tower 3 cools the circulating water. The circulating water filter 4 filters the circulating water to remove impurities in the circulating water. In this manner, the cooled and filtered circulating water is provided to the semiconductor manufacturing apparatuses 9a to 9d. When the circulating water in the circulating water providing system is insufficient, makeup water (supplementary water) is added to the circulating water tank 1.

The feed main pipe 11 is a main pipe for feeding the circulating water from the circulating water tank 1 to the semiconductor manufacturing apparatuses 9a to 9d. The feed main pipe 11 feeds the circulating water to flow in a direction from the circulating water tank 1 to the semiconductor manufacturing apparatuses 9a to 9d. The feed main pipe 11 is connected to the circulating water tank 1, the circulating water pump 2, the circulating water cooling tower 3 and the circulating water filter 4 via the pipe 13. The semiconductor manufacturing apparatuses 9a to 9d are connected to the feed main pipe 11 via the feed sub-pipes 15a to 15d, respectively. Therefore, the circulating water from the circulating water tank 1 is fed to the semiconductor manufacturing apparatuses 9a to 9d via the pipe 13, the feed main pipe 11 and the feed sub-pipes 15a to 15d.

The return main pipe 12 is a main pipe for returning the circulating water from the semiconductor manufacturing apparatuses 9a to 9d to the circulating water tank 1. The return main pipe 12 feeds the circulating water to flow in a direction from the semiconductor manufacturing apparatuses 9a to 9d to the circulating water tank 1. The return main pipe 12 is connected to the circulating water tank 1 via the pipe 14. The semiconductor manufacturing apparatuses 9a to 9d are connected to the return main pipe 12 via the return sub-pipes 16a to 16d, respectively. Therefore, the circulating water discharged from the semiconductor manufacturing apparatuses 9a to 9d is returned to the circulating water tank 1 via the return sub-pipes 16a to 16d, the return main pipe 12 and the pipe 14.

The feed main pipe 11 and the return main pipe 12 of the present embodiment are made of metal such as steel in order to pass a large amount of the circulating water. On the other hand, the feed sub-pipes 15a to 15d and the return sub-pipes 16a to 16d of the present embodiment are made of flexible resin so that these sub-pipes can be easily connected to the semiconductor manufacturing apparatuses 9a to 9d whose inlets and outlets for the circulating water are disposed at various locations. Examples of the feed sub-pipes 15a to 15d and the return sub-pipes 16a to 16d include resin hoses. When the resin hoses are used, there are an advantage in ease of pipe installation and an advantage in terms of cost, for example.

The first pressure detector 5 is disposed on the feed main pipe 11 to detect a feed pressure P₁ of the circulating water flowing in the feed main pipe 11. The first pressure detector 5 transmits a measurement result of the feed pressure P₁ of the circulating water to the controller 7.

The controller 7 controls operation of the circulating water pump 2, based on the feed pressure P₁ of the circulating water detected by the first pressure detector 5. More specifically, the controller 7 controls the operation of the circulating water pump 2 so that the pressure P₁ detected by the first pressure detector 5 is maintained at a certain level. For example, when the pressure P₁ is less than a setting value, the controller 7 increases the pressure P₁ by increasing the rotation speed of the circulating water pump 2. On the other hand, when the pressure P₁ is more than the setting value, the controller 7 decreases the pressure P₁ by decreasing the rotation speed of the circulating water pump 2.

The second pressure detector 6 is disposed on the return main pipe 12 to detect a pressure P₂ of a gas in the return main pipe 12. The second pressure detector 6 transmits a measurement result of the pressure P₂ of the gas in the return main pipe 12 to the controller 7.

The controller 7 controls an opening degree of the control valve 8, based on the pressure P₂ of the gas in the return main pipe 12 detected by the second pressure detector 6. The control valve 8 is disposed on the pipe 14 between the return main pipe 12 and the circulating water tank 1. The controller 7 can control a flow rate of the circulating water flowing in the pipe 14 by controlling the opening degree of the control valve 8.

The controller 7 of the present embodiment controls the opening degree of the control valve 8 so that the pressure P₂ detected by the second pressure detector 6 does not change to a negative pressure. More specifically, the controller 7 controls the opening degree of the control valve 8 so that the pressure P₂ detected by the second pressure detector 6 is maintained at a certain positive pressure. In the present embodiment, an example of the positive pressure is 0.05 MPa (gauge pressure).

Therefore, the controller 7 of the present embodiment decreases the opening degree of the control valve 8 with decrease in the pressure P₂ detected by the second pressure detector 6. For example, in a case where the opening degree of the control valve 8 is X₁ in a normal state, when the pressure P₂ decreases from 0.05 MPa to 0.04 MPa, the controller 7 decreases the opening degree of the control valve 8 from X₁ to X₂ (<X₁) to increase the pressure P₂ to 0.05 MPa. When the pressure P₂ changes to 0.03 MPa, the controller 7 sets the opening degree of the control valve 8 to X₃ (<X₂) to increase the pressure P₂ to 0.05 MPa. When the pressure P₂ changes to 0 MPa (gauge pressure), the controller 7 sets the opening degree of the control valve 8 to zero to close the control valve 8.

Reference symbol K₁ denotes an end portion of the pipe 14 at a side of the circulating water tank 1. Reference symbol K₂ denotes an end portion of the pipe 14 at a side of the return main pipe 14. The end portion K₂ corresponds to a connection portion of the pipe 14 with the return main pipe 14. Reference symbol K denotes an intermediate point along the pipe 14 between the end portion K₁ and the end portion K₂. The control valve 8 of the present embodiment is preferably arranged at a position close to the end portion K₂ so that the change of the opening degree of the control valve 8 quickly affects the pressure P₂. Therefore, the control valve 8 of the present embodiment is arranged on the pipe 14 at a side of the end portion K₂ with respect to the intermediate point K.

Reference symbols Ka to Kd respectively denote connection portions of the return sub-pipes 16a to 16d with the return main pipe 12. The return sub-pipes 16a to 16d of the present embodiment respectively include horseshoe shaped tube portions 21a to 21d near the connection portions Ka to Kd.

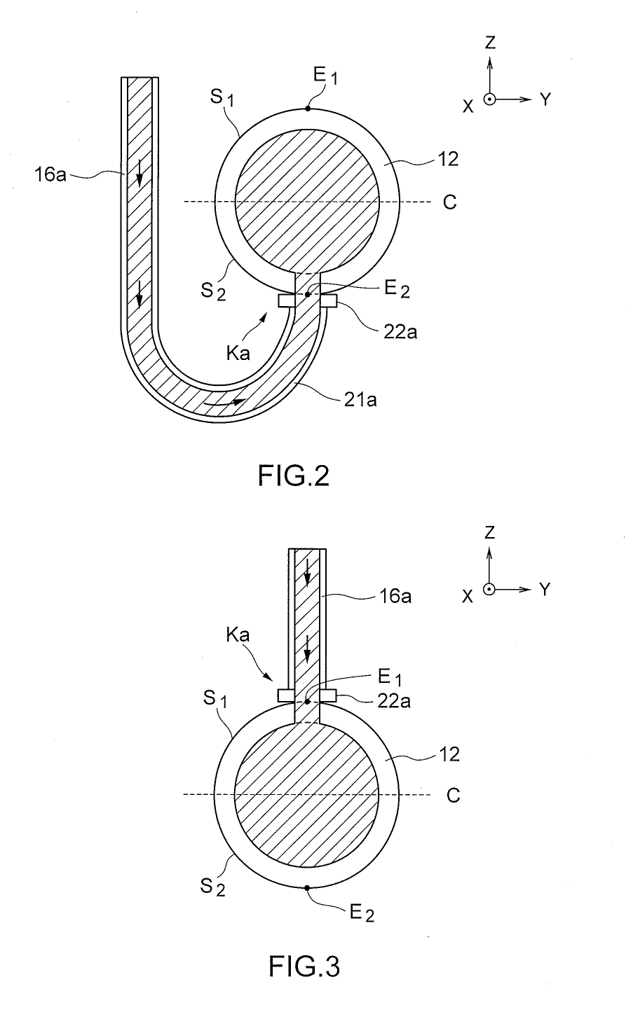

Details of the return sub-pipe 16a and the horseshoe shaped tube portion 21a will be explained with reference to FIGS. 2 to 6. The following explanation is also applicable to the return sub-pipes 16b to 16d and the horseshoe shaped tube portions 21b to 21d in the same manner.

FIG. 2 is a cross sectional view illustrating the connection portion Ka of the return sub-pipe 16a of the first embodiment.

FIG. 2 is a cross sectional view perpendicular to a pipe extension direction (X direction) of the return main pipe 12. Reference symbol C denotes a center line of a cross section of the return main pipe 12. The center line C extends in the Y direction. Reference symbol S₁ denotes an upper face of the return main pipe 12 located above the center line C. Reference symbol S₂ denotes a lower face of the return main pipe 12 located below the center line C.

Reference symbols E₁ and E₂ respectively denote an upper end and a lower end of the return main pipe 12. The upper end (upper end line) E₁ extends along the pipe extension direction, and reference symbol E₁ of FIG. 2 denotes a point on this line. Likewise, the lower end (lower end line) E₂ extends along the pipe extension direction, and reference symbol E₂ of FIG. 2 denotes a point on this line.

The return sub-pipe 16a of the present embodiment is connected to the lower face S₂ of the return main pipe 12 with a joint 22a of the connection portion Ka. More specifically, the return sub-pipe 16a is connected to the return main pipe 12 so as to include the lower end E₂ of the return main pipe 12. As a result, the return sub-pipe 16a includes the horseshoe shaped tube portion 21a at a side of the lower face S₂ of the return main pipe 12, i.e., at a position lower than the center line C of the return main pipe 12.

FIG. 3 is a cross sectional view illustrating a connection portion Ka of a return sub-pipe 16a of a comparative example of the first embodiment.

The return sub-pipe 16a of this comparative example is connected to the upper face S₁ of the return main pipe 12 with a joint 22a of the connection portion Ka. More specifically, the return sub-pipe 16a is connected to the return main pipe 12 so as to include the upper end E₁ of the return main pipe 12.

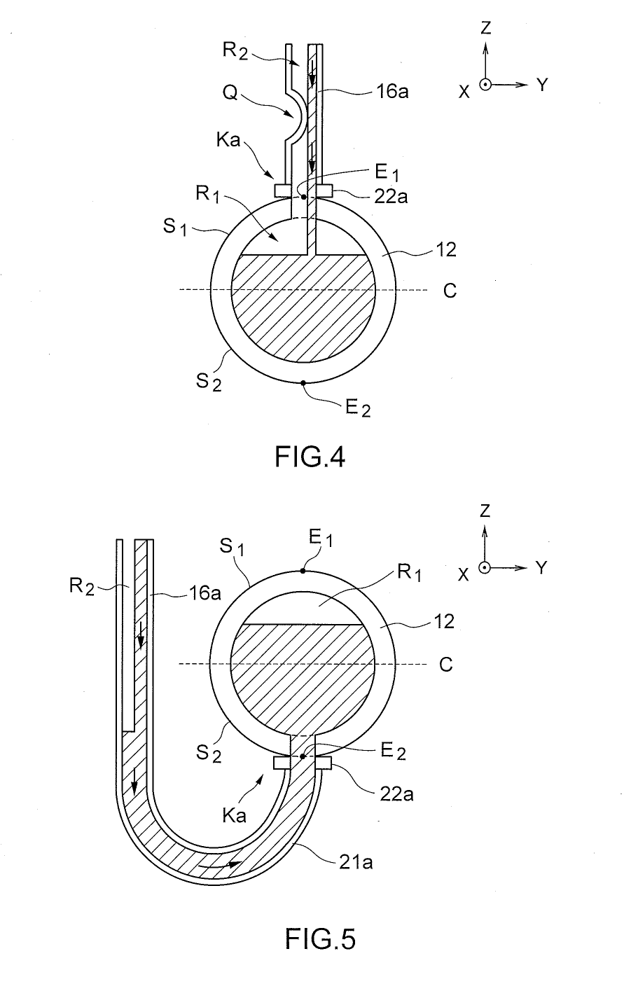

FIG. 4 is a cross sectional view for explaining a problem associated with the connection portion Ka of the comparative example of the first embodiment.

FIG. 4 illustrates a state in which the return main pipe 12 is no longer filled with the circulating water. Therefore, a space R₁ including the gas is generated in the return main pipe 12, and a space R₂ including the gas is also generated in the return sub-pipe 16a. In this case, when the pressure of the space R₁ in the return main pipe 12 becomes a negative pressure, the pressure of the space R₂ in the return sub-pipe 16a also becomes a negative pressure. Therefore, the return sub-pipe 16a is pressed by the atmospheric pressure, and a malfunction occurs to deform the return sub-pipe 16a. Reference symbol Q denotes a deformed portion of the return sub-pipe 16a.

FIG. 5 is a cross sectional view for explaining an advantage associated with the connection portion Ka of the first embodiment.

FIG. 5 illustrates a state in which the return main pipe 12 is no longer filled with the circulating water like FIG. 4. Therefore, a space R₁ including the gas is generated in the return main pipe 12, and a space R₂ including the gas is also generated in the return sub-pipe 16a.

However, the return sub-pipe 16a of the present embodiment is connected to the lower face S₂ of the return main pipe 12. Therefore, even when the return main pipe 12 is no longer filled with the circulating water, the circulating water is accumulated near the connection portion Ka of the return sub-pipe 16a. FIG. 5 illustrates a state in which the circulating water is accumulated in the horseshoe shaped tube portion 21a of the return sub-pipe 16a.

Therefore, the space R₂ in the return sub-pipe 16a of the present embodiment is separated from the space R₁ in the return main pipe 12 by the circulating water. Therefore, even when the pressure of the space R₁ in the return main pipe 12 becomes a negative pressure, the pressure of the space R₂ in the return sub-pipe 16a can be prevented from being a negative pressure. Therefore, according to the present embodiment, the return sub-pipe 16a is prevented from being pressed by the atmospheric pressure, and therefore the return sub-pipe 16a can be prevented from being deformed.

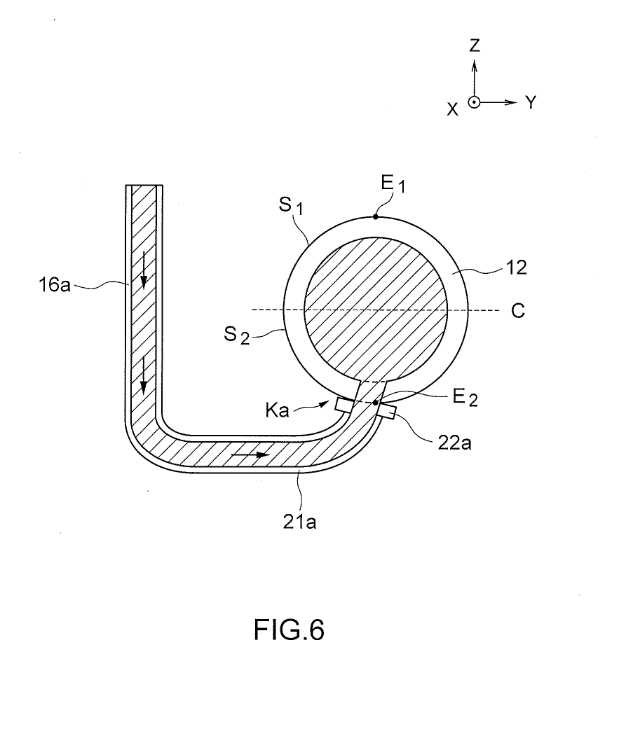

FIG. 6 is a cross sectional view illustrating the connection portion Ka of the return sub-pipe 16a of a modification of the first embodiment.

The bottom portion of the horseshoe shaped tube portion 21a of FIG. 2 has a substantially semicircular cross sectional shape having a certain curvature radius. In contrast, the bottom portion of the horseshoe shaped tube portion 21a of FIG. 6 has a cross sectional shape greatly different from the semicircular shape. The return sub-pipe 16a of the present embodiment may include a horseshoe shaped tube portion 21a in any shape as long as it is connected to the lower face S₂ of the return main pipe 12.

The return sub-pipe 16a of the present embodiment may be connected to a portion other than the end portion E₂ of the return main pipe 12 as long as it is connected to the lower face S₂ of the return main pipe 12. However, the return sub-pipe 16a of the present embodiment is preferably connected to the end portion E₂ of the return main pipe 12 so that the space R₂ can be separated from the space R₁ even if the lower face of the space R₁ decreases to a level close to the end portion E₂.

Any of the return sub-pipes 16a of FIGS. 2 and 6 is connected to the return main pipe 12 so as to include the lower end E₂ of the return main pipe 12. However, the return sub-pipe 16a of FIG. 2 is connected to the portion right below the return main pipe 12 in a state that the return sub-pipe 16a faces upward. On the other hand, the return sub-pipe 16a of FIG. 6 is connected to a position away from the portion right below the return main pipe 12 in a state that the return sub-pipe 16a is inclined. The return sub-pipe 16a of the present embodiment may be connected to the return main pipe 12 in any of the states of FIGS. 2 and 6.

As described above, the circulating water providing system of the present embodiment detects the pressure P₂ of the space R₁ in the return main pipe 12 by using the second pressure detector 6, and automatically controls the opening degree of the control valve 8 in the pipe 14 based on the pressure P₂ detected by the second pressure detector 6. Therefore, according to the present embodiment, the pressure P₂ of the space R₁ in the return main pipe 12 can be prevented from being a negative pressure.

Furthermore, each of the return sub-pipes 16a to 16d of the present embodiment is connected to the lower face S₂ of the return main pipe 12. Therefore, according to the present embodiment, even if the pressure of the space R₁ in the return main pipe 12 becomes a negative pressure, the pressure of the space R₂ in each of the return sub-pipes 16a to 16d can be prevented from being a negative pressure.

For example, when the pressure of the space R₂ in the return sub-pipe 16a becomes a negative pressure, the return sub-pipe 16a is pressed by the atmospheric pressure, and therefore the return sub-pipe 16a is deformed. As a result, the amount of the circulating water in the system does not attain a rated amount. In this case, the circulating water pump 2 tries to compensate the lack of the amount of the circulating water by increasing the amount of the circulating water, and therefore the circulating water pump 2 consumes too much electric power. However, according to the present embodiment, the deformation of the return sub-pipe 16a due to the negative pressure can be suppressed, and therefore excessive power consumption of the circulating water pump 2 can be suppressed.

As described above, according to the present embodiment, a malfunction of the return sub-pipes 16a to 16d due to the gas in the return main pipe 12 and the return sub-pipes 16a to 16d can be suppressed.

While certain embodiments have been described, these embodiments have been presented by way of example only, and are not intended to limit the scope of the inventions. Indeed, the novel systems and methods described herein may be embodied in a variety of other forms; furthermore, various omissions, substitutions and changes in the form of the systems and methods described herein may be made without departing from the spirit of the inventions. The accompanying claims and their equivalents are intended to cover such forms or modifications as would fall within the scope and spirit of the inventions.

1. A circulating water providing system comprising:
a tank configured to store water;
a first pipe configured to feed the water to flow in a direction from the tank to one or more manufacturing apparatuses;
a second pipe configured to feed the water to flow in a direction from the one or more manufacturing apparatuses to the tank;
a third pipe configured to return the water from the second pipe to the tank;
a detector configured to detect a pressure of a gas in the second pipe;
a valve disposed on the third pipe; and
a controller configured to control an opening degree of the valve, based on the pressure of the gas detected by the detector.

2. The system of claim 1, wherein the controller controls the opening degree of the valve so that the pressure detected by the detector does not change to a negative pressure.

3. The system of claim 1, wherein the controller decreases the opening degree of the valve with decrease in the pressure detected by the detector.

4. The system of claim 1, wherein
the third pipe includes a first end portion at a side of the tank and a second end portion at a side of the second pipe, and
the valve is arranged at a side of the second end portion with respect to an intermediate point between the first end portion and the second end portion.

5. The system of claim 1, further comprising a connection pipe connecting between one of the manufacturing apparatuses and the second pipe, and connected to a lower face of the second pipe.

6. The system of claim 5, wherein the connection pipe is connected to the second pipe so as to include a lower end of the second pipe.

7. The system of claim 5, wherein the connection pipe includes a horseshoe shaped tube portion at a lower face side of the second pipe.

8. The system of claim 5, wherein the connection pipe is made of a flexible resin material.

9. A circulating water providing system comprising:
a tank configured to store water;
a first pipe configured to feed the water to flow in a direction from the tank to one or more manufacturing apparatuses;
a second pipe configured to feed the water to flow in a direction from the one or more manufacturing apparatuses to the tank; and
a connection pipe connecting one of the manufacturing apparatuses and the second pipe, and connected to a lower face of the second pipe.

10. The system of claim 9, wherein the connection pipe is connected to the second pipe so as to include a lower end of the second pipe.

11. The system of claim 9, wherein the connection pipe includes a horseshoe shaped tube portion at a lower face side of the second pipe.

12. The system of claim 9, wherein the connection pipe is made of a flexible resin material.

13. A circulating water providing method comprising:
storing water to a tank;
feeding the water to flow in a direction from the tank to one or more manufacturing apparatuses via a first pipe;
feeding the water to flow in a direction from the one or more manufacturing apparatuses to the tank via a second pipe;
returning the water from the second pipe to the tank via a third pipe;
detecting a pressure of a gas in the second pipe by using a detector; and
controlling an opening degree of the valve disposed on the third pipe, based on the pressure of the gas detected by the detector.

14. The method of claim 13, wherein the opening degree of the valve is controlled so that the pressure detected by the detector does not change to a negative pressure.

15. The method of claim 13, wherein the opening degree of the valve is decreased with decrease in the pressure detected by the detector.

16. The method of claim 13, wherein
the third pipe includes a first end portion at a side of the tank and a second end portion at a side of the second pipe, and
the valve is arranged at a side of the second end portion with respect to an intermediate point between the first end portion and the second end portion.

17. The method of claim 13, wherein the second pipe is connected to one of the manufacturing apparatuses via a connection pipe which is connected to a lower face of the second pipe.

18. The method of claim 17, wherein the connection pipe is connected to the second pipe so as to include a lower end of the second pipe.

19. The method of claim 17, wherein the connection pipe includes a horseshoe shaped tube portion at a lower face side of the second pipe.

20. The method of claim 17, wherein the connection pipe is made of a flexible resin material.
